(19) United States
(12) Patent Application Publication
(10) Pub. No.: US 2015/0329106 A1
(43) Pub. Date: Nov. 19, 2015

(54) CONTROL DEVICE FOR HYBRID VEHICLE

(71) Applicants: Seiji KUWAHARA, (US); Toshio SUGIMURA, (US); Takahiko TSUTSUMI, (US); Koki MINAMIKAWA, (US); Shun SATO, (US)

(72) Inventors: Seiji KUWAHARA, Toyota-shi (JP); Toshio SUGIMURA, Nagoya-shi (JP); Takahiko TSUTSUMI, Nisshin-shi (JP); Koki MINAMIKAWA, Nagoya-shi (JP); Shun SATO, Toyota-shi (JP)

(73) Assignee: TOYOTA JIDOSHA KABUSHIKI KAISHA, Toyota-shi, Aichi (JP)

(21) Appl. No.: 14/651,906

(22) PCT Filed: Dec. 12, 2012
(86) PCT No.: PCT/JP2012/082260

§ 371 Date: Jun. 12, 2015

(51) Int. Cl. B60W 20/00; B60W 10/30; B60W 10/06; B60W 10/02; B60W 10/08

(52) U.S. Cl. CPC B60W 20/50; B60W 10/02; B60W 10/08; B60W 10/06; B60W 10/30; B60W 2510/02; B60W 2710/08; Y10S 903/93

(57) ABSTRACT

A control device of a hybrid vehicle includes: an engine; a first electric motor; a second electric motor coupled to a drive shaft of the engine; a clutch disposed in a power transmission path between the engine and the first electric motor; an electric oil pump generating an oil pressure by electric power; a mechanical oil pump included in a power transmission path closer to the first electric motor relative to the clutch, the mechanical oil pump generating an oil pressure by a drive force of at least one of the engine and the first electric motor; and an electric storage device giving/receiving electric power to/from the second electric motor and supplying electric power to the electric oil pump. When an open failure occurs in the clutch, the second electric motor generates electricity by driving the engine and an oil amount supplied from the electric oil pump is larger than an oil amount supplied from the mechanical oil pump.

### TECHNICAL FIELD

The present invention relates to a control device of a hybrid vehicle including a clutch in a power transmission path between an engine and an electric motor and particularly to an improvement for extending a cruising distance if an open failure occurs in the clutch.

### BACKGROUND ART

A hybrid vehicle is known that includes an engine, a first electric motor, a second electric motor coupled to a drive shaft of the engine, a clutch disposed in a power transmission path between the engine and the first electric motor, and an electric oil pump generating an oil pressure by electric power. For example, this corresponds to a vehicle hybrid drive device described in Patent Document 1.

### PRIOR ART DOCUMENT

### Patent Documents

Patent Document 1: Japanese Laid-Open Patent Publication No. 11-082261

Patent Document 2: Japanese Laid-Open Patent Publication No. 2007-069788

### SUMMARY OF THE INVENTION

### Problem to be Solved by the Invention

In a configuration including a clutch in a power transmission path between an engine and a first electric motor as in the convention technique, if an open failure occurs in the clutch, an oil pressure must be ensured by actuating the electric oil pump to generate the oil pressure or by actuating a mechanical oil pump by driving the first electric motor etc. However, if the clutch has an open failure, a drive fore for running must be generated by the first electric motor and, therefore, if the electric oil pump or the first electric motor is actuated for ensuring the oil pressure, electric power usable for running of the vehicle decreases, resulting in a trouble that a cruising distance becomes short. Such a trouble is particularly notable at the start of a vehicle held at rest. Such a problem is newly found out by the present inventors in the course of extensive studies with the intention of improving the performance of a hybrid vehicle.

The present invention was conceived in view of the situations and it is therefore an object of the present invention to provide a control device of a hybrid vehicle extending a cruising distance if an open failure occurs in a clutch disposed between an engine and an electric motor.

### Means for Solving the Problem

To achieve the object, the first aspect of the present invention provides a control device of a hybrid vehicle comprising: an engine; a first electric motor; a second electric motor coupled to a drive shaft of the engine; a clutch disposed in a power transmission path between the engine and the first electric motor; an electric oil pump generating an oil pressure by electric power; a mechanical oil pump included in a power transmission path closer to the first electric motor relative to the clutch, the mechanical oil pump generating an oil pressure by a drive force of at least one of the engine and the first electric motor; and an electric storage device giving/receiving electric power to/from the second electric motor and supplying electric power to the electric oil pump, wherein when an open failure occurs in the clutch, the second electric motor generates electricity by driving the engine.

### Effects of the Invention

According to the first aspect of the invention, when the open failure occurs in the clutch, since the second electric motor generates electricity by driving the engine, the electric generation by the second electric motor facilitates securing of the electric power used in the electric oil pump and can reduce the proportion of the electric power used for actuating the mechanical oil pump by the first electric motor and, therefore, a reduction in electric power used for generating a drive force for running by the first electric motor can preferably be suppressed. Therefore, this enables provision of the control device of the hybrid vehicle extending a cruising distance if the open failure occurs in the clutch disposed between the engine and the electric motor.

The second aspect of the present invention depending on the first aspect of the invention provides the control device of a hybrid vehicle, wherein when an open failure occurs in the clutch, an oil amount supplied from the electric oil pump is larger than an oil amount supplied from the mechanical oil pump. Consequently, if the open failure occurs in the clutch, a proportion of the electric power used for actuating the mechanical oil pump by the first electric motor can be reduced, and a reduction in electric power used for generating a drive force for running by the first electric motor can preferably be suppressed.

The third aspect of the present invention depending on the first or second aspect of the invention provides the control device of a hybrid vehicle, comprising a first electric storage device giving/receiving electric power exclusively to/from the first electric motor, and a second electric storage device giving/receiving electric power to/from the second electric motor and supplying electric power to the electric oil pump. Consequently, if the open failure occurs in the clutch, the electric generation by the second electric motor facilitates securing of the electric power used in the electric oil pump and therefore can reduce the proportion of the electric power used for actuating the mechanical oil pump by the first electric motor, and a reduction in electric power used for generating a drive force for running by the first electric motor can preferably be suppressed.

### BRIEF DESCRIPTION OF THE DRAWINGS

FIG. 1 is a conceptual diagram of a configuration of a drive system according to a hybrid vehicle to which the present invention is preferably applied.

FIG. 2 is a diagram exemplarily illustrating a control system included in the hybrid vehicle depicted in FIG. 1.

FIG. 3 is a hydraulic circuit diagram exemplarily depicting a partial configuration of a hydraulic control circuit included in the hybrid vehicle depicted in FIG. 1.

FIG. 4 is a function block diagram exemplarily illustrating a main portion of the control function included in an electronic control device in the hybrid vehicle depicted in FIG. 1.

FIG. 5 is a flowchart for explaining a main portion of an example of a clutch open failure time control of this embodiment according to the electronic control device in the hybrid vehicle depicted in FIG. 1.

### MODE FOR CARRYING OUT THE INVENTION

The present invention is preferably applied to a hybrid vehicle that has a crankshaft of the engine connected via the clutch to a rotor of the first electric motor and that includes a torque converter and an automatic transmission in a power transmission path between the rotor and drive wheels. The present invention may also be applied to a hybrid vehicle including an automatic transmission in a power transmission path between the first electric motor and drive wheels without passing through a torque converter.

In the present invention, preferably, the second electric motor may output a torque smaller than that of the first electric motor. In other words, the first electric motor is an electric motor with relatively high output and the second electric motor is an electric motor with relatively low output. The second electric motor may be any electric motor capable of acting as an electric generator and may not necessarily act as a drive source.

In the present invention, preferably, the second electric storage device may store an electric energy smaller than that of the first electric storage device. In other words, the first electric storage device is an electric storage device with relatively high voltage and the second electric storage device is an electric storage device with relatively low voltage.

In the present invention, preferably, an open failure of the clutch is determined based on a difference between an input rotation speed and an output rotation speed of the clutch. For example, if the difference between the input rotation speed and the output rotation speed of the clutch is equal to or greater than a predefined threshold value after a prescribed time has elapsed from output of a command causing engagement of the clutch, it is determined that the clutch has an open failure.

A preferred embodiment of the present invention will now be described in detail with reference to the drawings.

### EMBODIMENT

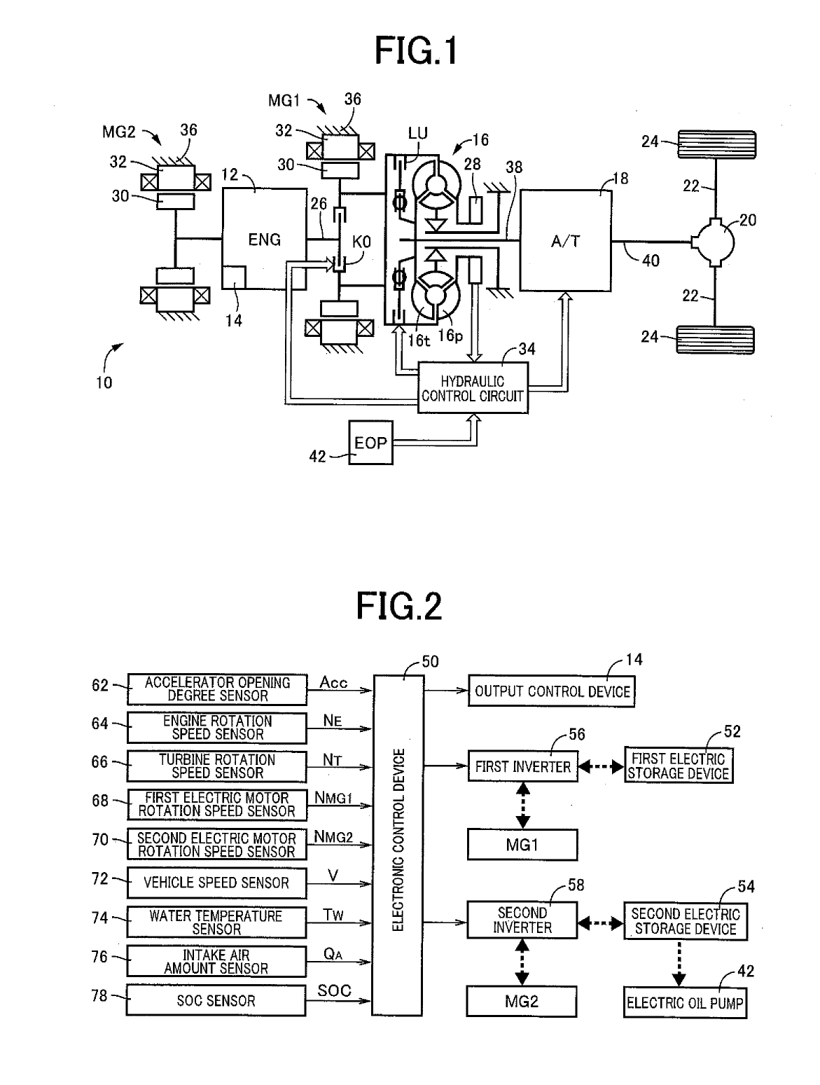

FIG. 1 is a conceptual diagram of a configuration of a drive system according to a hybrid vehicle 10 to which the present invention is preferably applied. The hybrid vehicle 10 depicted in FIG. 1 includes an engine 12, a first electric motor MG1, and a second electric motor MG2 coupled to a drive shaft (a crankshaft 26) of the engine 12, and a drive force generated by the engine 12 and the first electric motor MG1 is transmitted through each of a torque converter 16, an automatic transmission 18, a differential gear device 20, and a pair of left and right axles 22 to a pair of left and right drive wheels 24. The first electric motor MG1, the second electric motor MG2, the torque converter 16, and the automatic transmission 18 are all housed in a transmission case 36. The transmission case 36 is a split-type case made of die-cast aluminum, for example, and is fixed to a non-rotating member such as a vehicle body. Because of this configuration, the hybrid vehicle 10 is driven by using at least one of the engine 12 and the first electric motor MG1 as a drive source for running. Therefore, one of a plurality of running modes is selectively established for the hybrid vehicle 10, such as an engine running mode using only the engine 12 as the drive source for running, an EV running (motor running) mode using only the first electric motor MG1 as the drive source for running, and a hybrid running (EHV running) mode using the engine 12 and the first electric motor MG1 as the drive sources for running.

The engine 12 is an internal combustion engine such as cylinder-injection gasoline and diesel engines in which fuel is directly injected into a combustion chamber, for example. To control the drive (output torque) of the engine 12, an output control device 14 is provided that includes a throttle actuator providing opening/closing control of an electronic throttle valve, a fuel injection device providing fuel injection control, and an ignition device providing ignition timing control and the like. The output control device 14 controls the opening/closing of the electronic throttle valve with the throttle actuator for the throttle control in accordance with commands supplied from an electronic control device 50 described later, controls fuel injection by the fuel injection device for the fuel injection control, and controls timing of ignition by the ignition device for the ignition timing control, thereby providing the output control of the engine 12.

Between a pump impeller 16p and a turbine impeller 16t of the torque converter 16, a lockup clutch LU is disposed for direct coupling such that the pump impeller 16p and the turbine impeller 16t are integrally rotated. The lockup clutch LU has an engagement state thereof controlled between engagement (complete engagement), slip engagement, and release (complete release) in accordance with an oil pressure supplied from a hydraulic control circuit 34. The pump impeller 16p of the torque converter 16 is coupled to a mechanical oil pump 28, and an oil pressure is generated by the mechanical oil pump 28 in accordance with the rotation of the pump impeller 16 and is supplied as an original pressure to the hydraulic control circuit 34. In the hybrid vehicle 10, the mechanical oil pump 28 is included in a power transmission path closer to the first electric motor MG1 relative to a clutch K0 described later. The hybrid vehicle 10 of this example is provided with an electric oil pump 42 generating an oil pressure by electric power along with the mechanical oil pump 28, and the oil pressure is generated by the electric oil pump 42 by using the electric power supplied from a second electric storage device 54 described later and is supplied as the original pressure to the hydraulic control circuit 34.

The automatic transmission 18 is a stepped automatic transmission in which one of a plurality of predefined shift stages (gear ratios) is selectively established, for example, and is configured with a plurality of engagement elements for selecting the gear stages. For example, the automatic transmission 18 includes a plurality of hydraulic friction engagement devices such as multiplate clutches and brakes subjected to engagement control by hydraulic actuators and the plurality of the hydraulic friction engagement devices is selectively engaged or released in accordance with the oil pressure supplied from the hydraulic control circuit 34, thereby selectively establishing one of a plurality of (e.g., first- to sixth-speed) forward shift stages (forward gear stages, forward running gear stages) or a backward shift stage (backward gear stage, backward running gear stage) in accordance with a combination of coupling states of the hydraulic friction engagement devices.

Both the first electric motor MG1 and the second electric motor MG2 preferably include a rotor 30 supported rotatably around a shaft center thereof by the transmission case 36 and a stator 32 integrally fixed to the transmission case 36 on the outer circumferential side of the rotor 30 and are motor generators having functions of a motor (mover) generating a drive force and a generator (electric generator) generating a reaction force. Preferably, the second electric motor MG2 may output a torque smaller than that of the first electric motor MG1. In other words, the first electric motor MG1 is an electric motor with relatively high output and the second electric motor MG2 is an electric motor with relatively low output. The second electric motor MG2 may be any electric motor capable of acting as an electric generator and may not necessarily act as a drive source. As shown in FIG. 2 which is explained later, the hybrid vehicle 10 includes a first electric storage device 52 such as a battery and a capacitor giving/receiving electric power exclusively to/from the first electric motor MG1, and the second electric storage device 54 such as a battery and a capacitor giving/receiving electric power to/from the second electric motor MG2 and supplying electric power to the electric oil pump 42. Preferably, the second electric storage device 54 may store an electric energy smaller than that of the first electric storage device 52. In other words, the first electric storage device 52 is an electric storage device with relatively high voltage (a high-voltage battery) and the second electric storage device 54 is an electric storage device with relatively low voltage (a low-voltage battery). In this embodiment, that the first electric storage device 52 gives/receives electric power exclusively (only) to/from the first electric motor MG1 intends that the first electric storage device 52 does not give/receive electric power to/from the second electric motor MG2 and the electric oil pump 42, and this does not exclude that the first electric storage device 52 gives/receives electric power to/from the other pieces of equipment than the second electric motor MG2 and the electric oil pump 42.

In a power transmission path between the engine 12 and the first electric motor MG1, the clutch K0 is disposed that controls power transmission through the power transmission path depending on an engagement state thereof. In particular, the crankshaft 26 is an output member of the engine 12 and is selectively coupled via the clutch K0 to the rotor 30 of the first electric motor MG1. The rotor 30 of the first electric motor MG1 is coupled to a front cover that is an input member of the torque converter 16. The clutch K0 is, for example, a multiplate hydraulic friction engagement device subjected to engagement control by a hydraulic actuator and has an engagement state thereof controlled between engagement (complete engagement), slip engagement, and release (complete release) in accordance with an oil pressure supplied from the hydraulic control circuit 34. Therefore, torque capacity thereof is controlled depending on an oil pressure supplied from the hydraulic control circuit 34. The engagement of the clutch K0 causes the power transmission (connection) through the power transmission path between the crankshaft 26 and the front cover of the torque converter 16 while the release of the clutch K0 interrupts the power transmission through the power transmission path between the crankshaft 26 and the front cover of the torque converter 16. The slip engagement of the clutch K0 causes the power transmission corresponding to the torque capacity (the transmission torque) of the clutch K0 through the power transmission path between the crankshaft 26 and the front cover of the torque converter 16.

FIG. 2 is a diagram exemplarily illustrating a control system included in the hybrid vehicle 10. The electronic control device 50 depicted in FIG. 2 includes a so-called microcomputer including a CPU, a RAM, a ROM, and an I/O interface, and the CPU executes signal processes in accordance with a program stored in advance in the ROM, while utilizing a temporary storage function of the RAM, to provide various types of control such as the drive control of the engine 12, the drive control of each of the first electric motor MG1 and the second electric motor MG2, the shift control and the automatic transmission 18, the engagement force control of the clutch K0, and the engagement control of the lockup clutch LU. The electronic control device 50 may be configured separately as a plurality of control devices as needed for the control of the engine 12, for the control of each of the first electric motor MG1 and the second electric motor MG2, for the control of the automatic transmission 18, etc., such that various types of control are provided by communicating information with each other. In this embodiment, the electronic control device 50 corresponds to a control device of the hybrid vehicle 10.

As depicted in FIG. 2, the electronic control device 50 is supplied with various input signals detected by sensors provided in the hybrid vehicle 10. For example, the electronic control device 50 receives inputs of a signal indicative of an accelerator opening degree A_{CC} detected by an accelerator opening degree sensor 62 in accordance with a depression amount of an accelerator pedal not depicted, a signal indicative of a rotation speed (engine rotation speed) N_{E} of the engine 12 detected by an engine rotation speed sensor 64, a signal indicative of a rotation speed (turbine rotation speed) N_{T} of the turbine impeller 16t of the torque converter 16 (corresponding to a rotation speed of an input shaft 38 of the automatic transmission 18) detected by a turbine rotation speed sensor 66, a signal indicative of a rotation speed (first electric motor rotation speed) N_{MG1} of the first electric motor MG1 detected by a first electric motor rotation speed sensor 68, a signal indicative of a rotation speed (second electric motor rotation speed) N_{MG2} of the second electric motor MG2 detected by a second electric motor rotation speed sensor 70, a signal indicative of a vehicle speed V (corresponding to a rotation speed of an output shaft 40 of the automatic transmission 18) detected by a vehicle speed sensor 72, a signal indicative of a cooling water temperature T_{W} of the engine 12 detected by a water temperature sensor 74, a signal indicative of an intake air amount Q_{A} of the engine 12 detected by an intake air amount sensor 76, and a signal indicative of an electric storage amount (a remaining capacity, a charge amount) SOC of each of the first and second electric storage devices 52, 54 detected by an SOC sensor 78.

The electronic control device 50 supplies various output signals to the devices provided in the hybrid vehicle 10. For example, the electronic control device 50 supplies to the portions a signal supplied to the output control device 14 of the engine 12 for the drive control of the engine 12, a signal supplied to a plurality of electromagnetic control valves in the hydraulic control circuit 34 for the shift control of the automatic transmission 18, a signal supplied to a linear solenoid valve in the hydraulic control circuit 34 for the engagement control of the clutch K0, a signal supplied to a linear solenoid valve in the hydraulic control circuit 34 for the engagement control of the lockup clutch LU, and a signal supplied to a linear solenoid valve in the hydraulic control circuit 34 for line pressure control.

As depicted in FIG. 2, the first electric motor MG1 is connected via a first inverter 56 to the first electric storage device 52 and, when the first inverter 56 is controlled by the electronic control device 50, drive current supplied to coils is adjusted and the drive of the first electric motor MG1 is controlled. In other words, the output torque of the first electric motor MG1 is increased and decreased by the control through the first inverter 56. The second electric motor MG2 is connected via a second inverter 58 to the second electric storage device 54 and, when the second inverter 58 is controlled by the electronic control device 50, drive current supplied to coils is adjusted and the drive of the second electric motor MG2 is controlled. In other words, the output torque of the second electric motor MG2 is increased and decreased by the control through the second inverter 58. Therefore, in the hybrid vehicle 10 of this embodiment, the first electric motor MG1 and the second electric motor MG2 are preferably connected to the respective individual inverters and electric storage devices to give/receive electric power via the corresponding inverters to the electric storage devices; however, the electric motors may be connected to a common inverter and electric storage device. For example, the first electric storage device 52 and the second electric storage device 54 may correspond to respective electric storage regions of the first electric motor MG1 and the second electric motor MG2 in a single electric storage device.

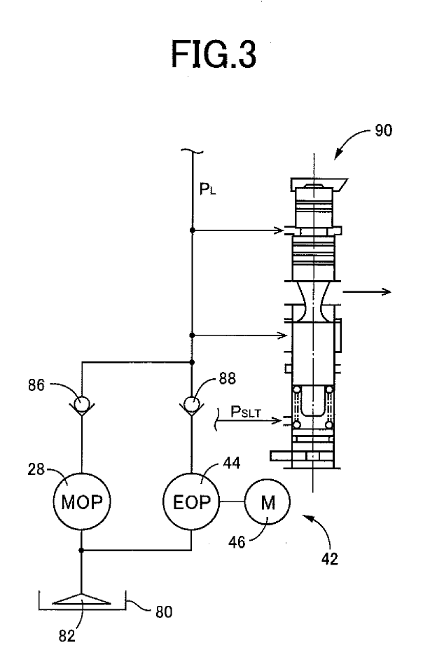

FIG. 3 is a hydraulic circuit diagram exemplarily depicting a partial configuration of the hydraulic control circuit 34. As depicted in FIG. 3, the hybrid vehicle 10 of this example includes the mechanical oil pump 28 coupled to the pump impeller 16p and generating an oil pressure by a drive force of at least one of the engine 12 and the first electric motor MG1, and the electric oil pump 42 generating an oil pressure by electric power supplied from the second electric storage device 54. The mechanical oil pump 28 is preferably configured as a gear oil pump made up of a driven gear and a drive gear not depicted. The electric oil pump 42 preferably includes a constant volume type gear pump 44 and an oil pump motor (electric motor) 46 for driving the gear pump 44 using electric power supplied from the second electric storage device 54, where rotation speed of the oil pump motor 46 is controllable. This oil pump motor 46 preferably has a smaller electric motor capacity as compared to the first electric motor MG1. The mechanical oil pump 28 is driven in an interlocking manner with the rotation of the pump impeller 16p. Therefore, if the pump impeller 16p is rotationally driven by at least one of the engine 12 and the first electric motor MG1, the mechanical oil pump 28 is driven and an oil pressure (a discharge amount) is output in accordance with rotation speed of the pump impeller 16p (=the first electric motor rotation speed N_{MG1}). The mechanical oil pump 28 is stopped while the pump impeller 16p is stopped. The electric oil pump 42 is driven by the oil pump motor 46 by using the electric power supplied from the second electric storage device 54. When rotation speed of the oil pump motor 46 is controlled, an oil pressure (a discharge amount) output from the gear pump 44 (the electric oil pump 42) is controlled.

As depicted in FIG. 3, in the hydraulic control circuit 34, preferably, the mechanical oil pump 28 and the electric oil pump 42 (the gear pump 44) are disposed in parallel and at least one of the mechanical oil pump 28 and the electric oil pump 42 is operated to pump up hydraulic oil stored in an oil pan 80 via a strainer 82. The hydraulic oil pumped up in this way is supplied via check valves 86, 88 to a regulator valve 90 disposed downstream of the oil pumps 28, 42. This regulator valve 90 uses the oil pressure supplied from the oil pumps 28, 42 as an original pressure to adjust a line pressure P_{L} in accordance with a command oil pressure P_{SLT} supplied from a linear solenoid valve not depicted.

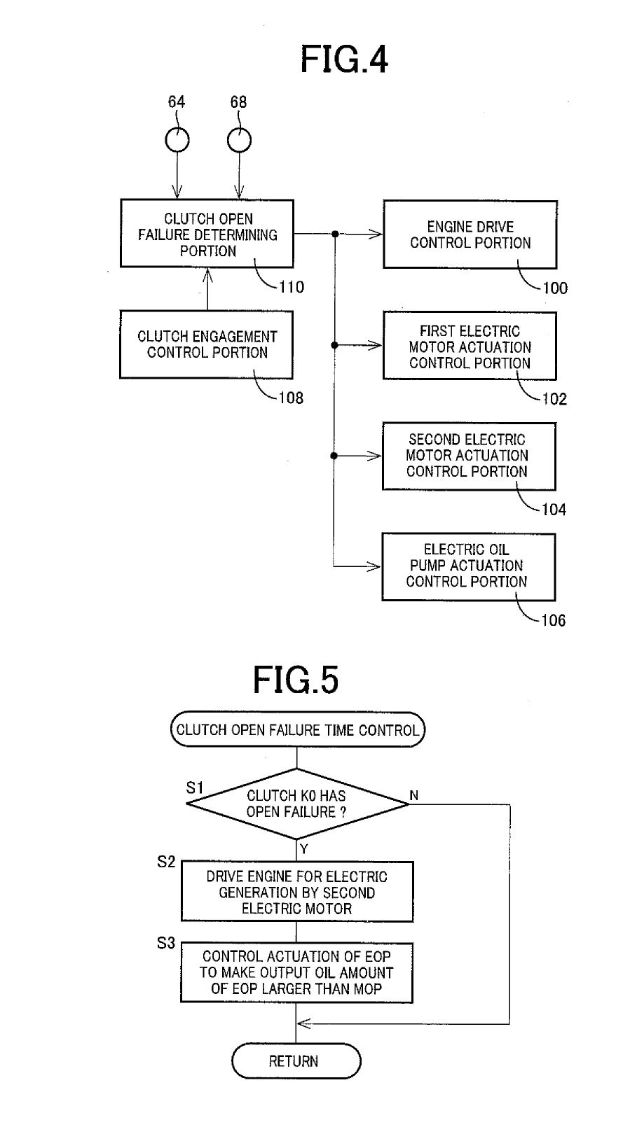

FIG. 4 is a function block diagram exemplarily illustrating a main portion of the control function included in the electronic control device 50. An engine drive control portion 100 depicted in FIG. 4 controls the drive (output torque) of the engine 12 via the output control device 14. Specifically, the engine drive control portion 100 controls a throttle valve opening degree θ_{TH} of the electronic throttle valve, the amount of fuel supply by the fuel injection device, the timing of ignition by the ignition device in the engine 12 through the output control device 14, thereby controlling the drive of the engine 12 such that a necessary engine output, i.e., a target engine output is acquired from the engine 12.

The engine drive control portion 100 drives the engine 12 in the engine running mode and the hybrid running (EHV running) mode. Therefore, at the time of switching from the EV running mode to the engine running mode or the hybrid running mode, the engine drive control portion 100 provides engine start control for starting the engine 12. For example, the clutch K0 is engaged to start the engine 12. In particular, the clutch K0 is slip-engaged or completely engaged to rotationally drive the engine 12 by a torque transmitted via the clutch K0. Alternatively, the engine 12 may be rotationally driven (cranked) by a drive force generated by the second electric motor MG2. The engine rotation speed N_{E} is raised by such rotational drive while the engine ignition and the fuel supply are started through the output control device 14 so as to start autonomous operation of the engine 12.

The engine drive control portion 100 stops the engine 12 in the EV running mode. Therefore, at the time of switching from the engine running mode or the hybrid running mode to the EV running mode, the engine drive control portion 100 provides engine stop control for stopping the engine 12. For example, the clutch K0 is released and the autonomous operation of the engine 12 is stopped. In particular, the clutch K0 is slip-engaged or completely released, and the engine ignition and the fuel supply are stopped through the output control device 14.

A first electric motor actuation control portion 102 controls the actuation of the first electric motor MG1 through the first inverter 56. In particular, basically, the first electric motor actuation control portion 102 provides control such that the electric energy is supplied from the first electric storage device 52 via the first inverter 56 to the first electric motor MG1 to acquire necessary output, i.e., target electric motor output, from the first electric motor MG1, or provides control such as storing the electric energy generated by the first electric motor MG1 into the first electric storage device 52 via the first inverter 56.

A second electric motor actuation control portion 104 controls the actuation of the second electric motor MG2 through the second inverter 58. In particular, basically, the second electric motor actuation control portion 104 provides control such that the electric energy is supplied from the second electric storage device 54 via the second inverter 58 to the second electric motor MG2 to acquire necessary output, i.e., target electric motor output, from the second electric motor MG2, or provides control such as storing the electric energy generated by the second electric motor MG2 into the second electric storage device 54 via the second inverter 58.

An electric oil pump actuation control portion 106 controls the actuation of the electric oil pump 42. In particular, basically, the electric oil pump actuation control portion 106 controls the electric energy (electric power) supplied from the second electric storage device 54 to the oil pump motor 46 via an inverter etc. not depicted to control the rotation speed of the oil pump motor 46 so as to provide control such that the oil pressure (discharge amount of hydraulic oil) generated by the gear pump 44 corresponding to the rotation speed of the oil pump motor 46 becomes equal to a target value (target oil pressure). In other words, the electric oil pump actuation control portion 106 controls the drive of the oil pump motor 46 to provide control such that a necessary oil pressure, i.e., a target oil pressure, is acquired from the electric oil pump 42.

A clutch engagement control portion 108 provides the engagement control of the clutch K0 via the linear solenoid valve included in the hydraulic control circuit 34. In particular, the clutch engagement control portion 108 controls a command value to the linear solenoid valve (a current supplied to a solenoid) to control the oil pressure supplied from the linear solenoid valve to a hydraulic actuator included in the clutch K0. This oil pressure control is provided to control the engagement state of the clutch K0 between engagement (complete engagement), slip engagement, and release (complete release) as mentioned above. As a result of the control of the clutch engagement control portion 108, the torque capacity (transmission torque) of the clutch K0 is controlled depending on an oil pressure supplied from the linear solenoid valve to the clutch K0. Therefore, in other words, the clutch engagement control portion 108 is a clutch torque capacity control portion controlling the torque capacity of the clutch K0 via the linear solenoid valve included in the hydraulic control circuit 34.

A clutch open failure determining portion 110 determines an open failure of the clutch K0. In particular, the clutch open failure determining portion 110 determines whether a failure (an open failure) occurs that the clutch K0 is left open regardless of a control command from the electronic control device 50. Specifically, if the clutch K0 is left open even though a command causing engagement of the clutch K0 is output from the clutch engagement control portion 108 to the linear solenoid valve included in the hydraulic control circuit 34, it is determined that the clutch K0 has the open failure. For example, after a prescribed time has elapsed from output of the command causing engagement of the clutch K0 from the clutch engagement control portion 108, if a difference between an input rotation speed and an output rotation speed of the clutch K0, i.e., a rotation speed difference ΔN (=|N_{E}-N_{MG1}|) between the engine rotation speed N_{E} detected by the engine rotation speed sensor 64 and the first electric motor rotation speed N_{MG1} detected by the first electric motor rotation speed sensor 68, is equal to or greater than a predefined threshold value, it is determined that the clutch K0 has the open failure.

If the open failure of the clutch K0 is determined by the clutch open failure determining portion 110 in the hybrid vehicle 10 of this embodiment, the second electric motor MG2 operates to generate electricity which is driven by the engine 12. In particular, the engine drive control portion 100 provides control such that the rotation speed N_{E} of the engine 12 becomes equal to a prescribed target value through the output control device 14 and the second electric motor actuation control portion 104 controls the actuation of the second electric motor MG2 such that the second electric motor MG2 operates to generate electricity. In other words, the electric energy is generated by the second electric motor MG2 through the control of the second electric motor actuation control portion 104 by using the drive force output from the engine 12 through the control of the engine drive control portion 100 and is stored via the second inverter 58 into the second electric storage device 54.

If the open failure of the clutch K0 is determined by the clutch open failure determining portion 110 in the hybrid vehicle 10 of this embodiment, the oil amount supplied from the electric oil pump 42 is larger than the oil amount supplied from the mechanical oil pump 28. If the clutch K0 is opened, the drive force of the engine 12 is not transmitted to the mechanical oil pump 28 and, therefore, the oil amount (discharged oil amount) supplied from the mechanical oil pump 28 is determined by the drive (the rotation speed N_{MG1}) of the first electric motor MG1. Thus, in this embodiment, specifically, if the open failure of the clutch K0 is determined by the clutch open failure determining portion 110, the actuation of the first electric motor MG1 (the rotation speed N_{MG1}) is controlled via the first electric motor actuation control portion 102 while the actuation of the electric oil pump 42 (the rotation speed of the oil pump motor 46) is controlled by the electric oil pump actuation control portion 106 such that the oil amount supplied from the electric oil pump 42 becomes larger than the oil amount supplied from the mechanical oil pump 28. In other words, with regard to the original pressure required for generating the prescribed line pressure P_{L} in the hydraulic control circuit 34, a proportion of the work load in each of the oil pumps 28 is controlled such that the work load on the electric oil pump 42 becomes larger than the work load on the mechanical oil pump 28.

FIG. 5 is a flowchart for explaining a main portion of an example of a clutch open failure time control of this embodiment according to the electronic control device 50 and is repeatedly executed in a predetermined period.

First, at step (hereinafter, step will be omitted) S1, it is determined whether a failure (an open failure) occurs that the clutch K0 is left open. If the determination of S1 is negative, this routine is then terminated, and if the determination of S1 is affirmative, the engine 12 is driven at S2 and the second electric motor MG2 generates electricity with the drive force output from the engine 12. The electric energy generated by the second electric motor MG2 is stored via the second inverter 58 into the second electric storage device 54. At S3, after the actuations of the first electric motor MG1 and the electric oil pump 42 (the oil pump motor 46) are controlled such that the oil amount supplied from the electric oil pump 42 becomes larger than the oil amount supplied from the mechanical oil pump 28, this routine is terminated. In the above control, the process of S3 may not necessarily be executed. S1 corresponds to the process of the clutch open failure determining portion 110; S2 corresponds to the processes of the engine drive control portion 100 and the second electric motor actuation control portion 104; and S3 corresponds to the processes of the first electric motor actuation control portion 102 and the electric oil pump actuation control portion 106.

According to this embodiment, when the open failure occurs in the clutch K0, since the second electric motor MG2 generates electricity by driving the engine 12, the electric generation by the second electric motor MG2 facilitates securing of the electric power used in the electric oil pump 42 and can reduce the proportion of the electric power used for actuating the mechanical oil pump 28 by the first electric motor MG1 and, therefore, a reduction in electric power used for generating a drive force for running by the first electric motor MG1 can preferably be suppressed. Therefore, this enables provision of the electronic control device 50 of the hybrid vehicle 10 extending a cruising distance if the open failure occurs in the clutch K0 disposed between the engine 12 and the first electric motor MG1.

In this embodiment, the oil pump motor 46 driving the electric oil pump 42 has a smaller electric motor capacity as compared to the first electric motor MG1. Therefore, the electric power required in the case of driving the electric oil pump 42 to ensure the oil pressure becomes smaller than the electric power required in the case of driving the mechanical oil pump 28 by the first electric motor MG1 to ensure the oil pressure. As a result, by increasing the proportion of the work load on the electric oil pump 42, the electric power required for ensuring the oil pressure becomes relatively small. Therefore, the electric power usable for driving the vehicle is increased as compared to the case of driving the mechanical oil pump 28 by the first electric motor MG1 to ensure the oil pressure, and the cruising distance at the time of the open failure of the clutch K0 can be extended.

When the open failure occurs in the clutch K0, the oil amount supplied from the electric oil pump 42 is larger than the oil amount supplied from the mechanical oil pump 28 and, therefore, if the open failure occurs in the clutch K0, a proportion of the electric power used for actuating the mechanical oil pump 28 by the first electric motor MG1 can be reduced, and a reduction in electric power used for generating a drive force for running by the first electric motor MG1 can preferably be suppressed.

Since the first electric storage device 52 giving/receiving electric power exclusively to/from the first electric motor MG1 is included along with the second electric storage device 54 giving/receiving electric power to/from the second electric motor MG2 and supplying electric power to the electric oil pump 42, if the open failure occurs in the clutch K0, the electric generation by the second electric motor MG2 facilitates securing of the electric power used in the electric oil pump 42 and therefore can reduce the proportion of the electric power used for actuating the mechanical oil pump 28 by the first electric motor MG1, and a reduction in electric power used for generating a drive force for running by the first electric motor MG1 can preferably be suppressed.

Although the preferred embodiment of the present invention has been described in detail with reference to the drawings, the present invention is not limited thereto and is implemented with various modifications applied within a range not departing from the spirit thereof.

### NOMENCLATURE OF ELEMENTS

10: hybrid vehicle 12: engine 14: output control device 16: torque converter 16p: pump impeller 16t: turbine impeller 18: automatic transmission 20: differential gear device 22: axles 24: drive wheels 26: crankshaft (drive shaft) 28: mechanical oil pump 30: rotor 32: stator 34: hydraulic control circuit 36: transmission case 38: input shaft 40: output shaft 42: electric oil pump 44: gear pump 46: oil pump motor 50: electronic control device 52: first electric storage device 54: second electric storage device 56: first inverter 58: second inverter 62: accelerator opening degree sensor 64: engine rotation speed sensor 66: turbine rotation speed sensor 68: first electric motor rotation speed sensor 70: second electric motor rotation speed sensor 72: vehicle speed sensor 74: water temperature sensor 76: intake air amount sensor 78: SOC sensor 80: oil pan 82: strainer 86, 88: check valve 90: regulator valve 100: engine drive control portion 102: first electric motor actuation control portion 104: second electric motor actuation control portion 106: electric oil pump actuation control portion 108: clutch engagement control portion 110: clutch open failure determining portion K0: clutch LU: lockup clutch MG1: first electric motor MG2: second electric motor

1. A control device of a hybrid vehicle comprising:
an engine;
a first electric motor;
a second electric motor coupled to a drive shaft of the engine;
a clutch disposed in a power transmission path between the engine and the first electric motor;
an electric oil pump generating an oil pressure by electric power;
a mechanical oil pump included in a power transmission path closer to the first electric motor relative to the clutch, the mechanical oil pump generating an oil pressure by a drive force of at least one of the engine and the first electric motor; and
an electric storage device giving/receiving electric power to/from the second electric motor and supplying electric power to the electric oil pump, wherein
when an open failure occurs in the clutch, the second electric motor generates electricity by driving the engine and an oil amount supplied from the electric oil pump is larger than an oil amount supplied from the mechanical oil pump.

2. (canceled)

3. The control device of a hybrid vehicle of claim 1, further comprising
a first electric storage device giving/receiving electric power exclusively to/from the first electric motor, and
a second electric storage device giving/receiving electric power to/from the second electric motor and supplying electric power to the electric oil pump
